(19) United States
(12) Patent Application Publication
(10) Pub. No.: US 2012/0140272 A1
(43) Pub. Date: Jun. 7, 2012

(54) PRINTING SYSTEM, IMAGE FORMING APPARATUS, AND METHOD

(75) Inventor: Nao Funane, Kawasaki-shi (JP)

(73) Assignee: CANON KABUSHIKI KAISHA, Tokyo (JP)

(21) Appl. No.: 13/304,258

(22) Filed: Nov. 23, 2011

(30) Foreign Application Priority Data
Dec. 2, 2010 (JP) 2010-269120

(51) Int. Cl. G06F 3/12

(52) U.S. Cl. 358/1.15

(57) ABSTRACT

An image forming apparatus configured to display a list data corresponding to a user, acquire information indicating an impact on the environment if the data included in the list is printed using one or a plurality of usable print settings, present the impact on the environment when the print settings are selected and print the data using the selected print settings according to a print instruction of the user.

### BACKGROUND OF THE INVENTION

1. Field of the Invention

The present invention relates to print settings to be performed when a user of an image forming apparatus requests and prints data managed by a server.

2. Description of the Related Art

When a user operates a copying machine or an image forming apparatus (hereinafter, collectively referred to as “device”), a requirement has recently been introduced to reduce the amount of carbon dioxide emissions and print costs considering an impact on the environment or for the purpose of reducing the costs. As discussed in Japanese Patent Application Laid-Open No. 2010-167577, it is useful to select two-sided printing rather than repeating one-sided printing or print two pages on one sheet to reduce the amount of carbon dioxide emissions and the print costs when the device is operated.

The method discussed in Japanese Patent Application Laid-Open No. 2010-167577 includes preliminarily evaluating the amount of carbon dioxide emissions for each sheet and each print setting item (e.g., monochrome/color). If a user performs printing, the method further includes displaying candidate settings that can effectively reduce the amount of carbon dioxide emissions in each print setting item to enable the user to select optimum print settings.

On the other hand, there is another conventional method including storing a document in an external storage that is accessible via the Internet and enabling users to operate an arbitrary device to perform printing of the document.

More specifically, the method includes uploading a document from an appropriate device (e.g., a personal computer (PC) or a mobile terminal) to an appropriate storage that is accessible via the Internet. A user who wants to perform a printing operation can operate an arbitrary device to download a printable document from the storage to the device via Internet and can print the document.

The above-described printing method is generally referred to as “pull print.” The pull print is useful for users in that a document available from such an Internet-based storage can be printed at any place and any time.

If a printer driver is installed on a PC, a user can instruct a device to perform printing of a document. For example, when an original to be printed is composed of two pages, the user may designate aggregation print setting (e.g., 2 in 1 printing) to print a plurality of (e.g., two) pages on one sheet, or may designate two-sided print setting, to reduce the amount of carbon dioxide emissions and print costs. Further, a user interface (UI) of the printer driver is easily operable on the PC, and the user can simply perform print settings using the UI.

However, according to the above-described pull print, for example, if a user uploads a document from a mobile terminal to an Internet-based device, the document can be simply stored in the storage without launching the printer driver.

In this case, when a user of the device directly prints a downloaded document, the document is generally printed without using any page aggregation setting or according to the one-sided print setting. As a result, the number of printed sheets increases. In other words, generally, printing may be performed without considering the amount of carbon dioxide emissions (i.e., the impact on the environment) and print costs. In general, carbon dioxide emissions may be directly proportional to the number of printed sheets.

To avoid the above-described situation, a user is required to determine print settings considering the amount of carbon dioxide emissions or print costs while operating a UI of the device. However, the conventional device presents a guidance that indicates the possibility of reducing the amount of carbon dioxide emissions in a printing operation compared to the present print settings. In this case, users are required to designate optimum print settings (e.g., page aggregation, two-sided printing, etc.) through a complicated procedure. Further, users may not change the print settings. As a result, users may perform printing operations unintentionally without considering the amount of carbon dioxide emissions.

In general, employees in a company are required to print documents according to a predetermined policy. For example, each employee is strongly recommended to select the 2 in 1 printing. However, if individual users can determine print settings freely, the print settings determined by the users may not be appropriate.

Further, the UI of the device is different from the UI of the printer driver in that users are required to operate with a touch panel (not a keyboard or a mouse). Further, the UI of the device has relatively poor operability because of a limited screen size. It is generally difficult for users to perform a complicated setting operation.

Further, according to the above-described pull print, it is difficult to identify a device to be used for printing before a print request is received. Therefore, if it is required to determine print settings considering the amount of carbon dioxide emissions, appropriate print settings cannot be determined before the device to be used is identified, because the amount of carbon dioxide emissions is variable depending on each device type even if the print contents are the same.

### SUMMARY OF THE INVENTION

One of the aspect of the present inventions is directed to a printing system, an image forming apparatus, and a method capable of, when a user of an image forming apparatus requests and prints data managed by an information processing apparatus, allowing the user to perform flexible print operations according to the user's requirements, within the print settings that are recommended by an administrator considering the impact on the environment and costs, with an easy and simple operation via an operation unit of the image forming apparatus.

According to an aspect of the present invention, a printing system includes an information processing apparatus and an image forming apparatus that performs print processing of data. The information processing apparatus includes a storage unit configured to store data registered by an external apparatus in association with user identification information; a first transmission unit configured to transmit a list of the stored data, which corresponds to user identification information transmitted from the image forming apparatus, to the image forming apparatus; a calculation unit configured to calculate information indicating an impact on the environment if the image forming apparatus performs printing of the data included in the list, using a plurality of print settings registered beforehand; a determination unit configured to determine one or a plurality of print settings that can be used in the printing of the data included in the list, with reference to a calculation result obtained by the calculation unit; a second transmission unit configured to transmit the usable one or plurality of print settings determined by the determination unit to the image forming apparatus; a third transmission unit configured to transmit the information indicating the impact on the environment calculated by the calculation unit to the image forming apparatus; and a fourth transmission unit configured to transmit the data included in the list to the image forming apparatus. The image forming apparatus includes a list acquisition unit configured to transmit identification information of a user who is currently operating the image forming apparatus to the information processing apparatus in accordance with an instruction received via an operation unit, and acquire a list of data that correspond to the user identification information from the information processing apparatus; a display unit configured to display the list of the data acquired by the list acquisition unit; a setting acquisition unit configured to acquire one or a plurality of print settings usable for printing from the information processing apparatus; a environmental impact acquisition unit configured to acquire information indicating an impact on the environment if printing of the data included in the list is performed using the one or the plurality of print settings acquired by the setting acquisition unit, from the information processing apparatus; a presenting unit configured to perform a presentation to enable users to select an appropriate one of the print settings acquired by the setting acquisition unit; a data acquisition unit configured to acquire the data included in the list from the information processing apparatus; and a printing unit configured to perform print processing on the data acquired by the data acquisition unit using appropriate print settings selected from the print settings presented by the presenting unit according to a print instruction received via the operation unit, wherein the presenting unit is configured to display the information indicating the impact on the environment acquired by the environmental impact acquisition unit, in accordance with the selection of the print settings, to indicate an evaluation value corresponding to the selected print settings.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example configuration of a printing system according to an exemplary embodiment of the present invention.

FIG. 2 is a block diagram illustrating an example of a hardware configuration of a device.

FIG. 3 is a block diagram illustrating an example of a hardware configuration of a print management apparatus.

FIG. 4 illustrates an example of a table that stores document information in a data storage unit of the print management apparatus 130.

FIG. 5 illustrates an example of a recommended print setting screen according to an exemplary embodiment of the present invention.

FIG. 6 is a flowchart illustrating an example of processing that can be performed by the print management apparatus when the device acquires a document list from the print management apparatus.

FIG. 7 illustrates an example of a document list screen according to a first exemplary embodiment of the present invention.

FIG. 8 is a flowchart illustrating an example of processing for displaying recommended print settings according to the first exemplary embodiment of the present invention.

FIG. 9 illustrates an example of a set of recommended print settings that can be stored in the data storage unit of the print management apparatus.

FIG. 10 illustrates an example of a print setting screen according to the first exemplary embodiment of the present invention.

FIG. 11 illustrates an example of a document list print setting screen according to a second exemplary embodiment of the present invention.

FIG. 12 illustrates an example of the document list print setting screen according to a third exemplary embodiment of the present invention.

FIG. 13 is a flowchart illustrating an example of processing for changing usable recommended print settings together for a plurality of documents according to the third exemplary embodiment of the present invention.

### DESCRIPTION OF THE EMBODIMENTS

Various exemplary embodiments, features, and aspects of the invention will be described in detail below with reference to the drawings.

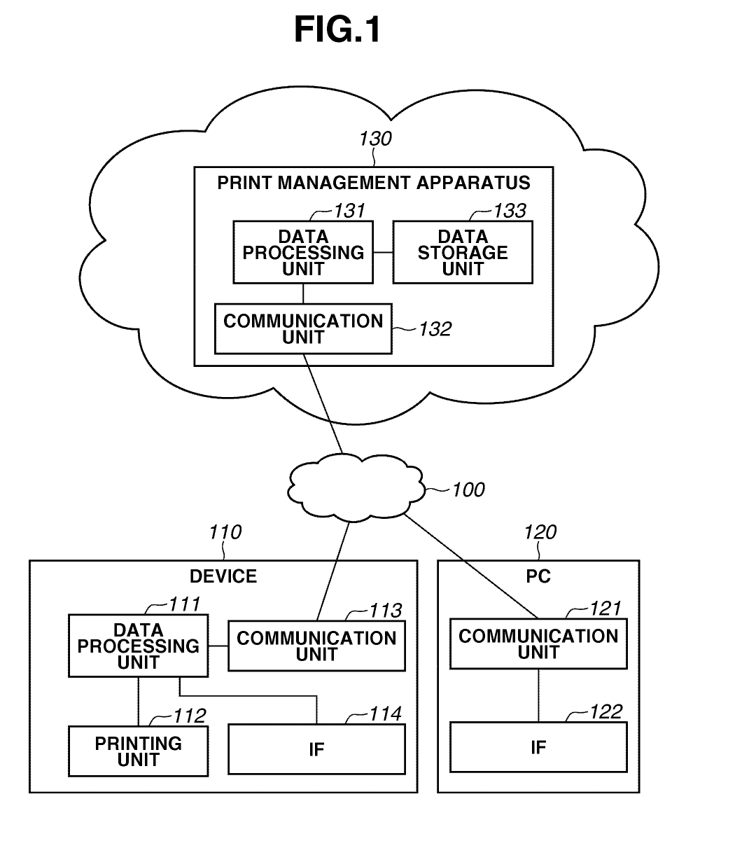

FIG. 1 illustrates an example configuration of a printing system according to an exemplary embodiment of the present invention.

In FIG. 1, a print management apparatus 130 is functionally operable as a storage unit configured to store document data and a management unit configured to manage print settings. The print management apparatus 130 is a server that can provide print management services via a network 100 (e.g., Internet or intranet).

A device 110 is an image forming apparatus, such as a copying machine. A personal computer (PC) 120 is at least operable as an information processing apparatus. The device 110 and the PC 120 can receive services from the print management apparatus 130 via the network 100.

The print management apparatus 130 includes a communication unit 132, which is connectable to an external device via the network 100. The communication unit 132 can perform communications with the device 110 and the PC 120 via the network 100.

The print management apparatus 130 includes a data processing unit 131 that can receive information from the device 110 and the PC 120 via the communication unit 132. The print management apparatus 130 is functionally operable as a processing unit configured to perform data processing and a management unit configured to perform print setting management. The print management apparatus 130 further includes a data storage unit 133 that can store document data and various setting values relating to the data processing.

The device 110 includes a communication unit 113, which is connectable to an external device via the network 100. The communication unit 113 can perform communications with the print management apparatus 130 via the network 100. The device 110 includes an interface (IF) 114, which is functionally operable as an operation panel of the device 110 to display an operation screen and enables users to input operational instructions.

The device 110 includes a data processing unit 111, which is functionally operable to perform processing in response to an operation received via the IF 114. The device 110 further includes a printing unit 112 that can receive a print request input by a user via the operation panel of the device 110 or received via the network 100, and can perform a printing operation.

The PC 120 includes a communication unit 121, which is connectable to an external device via the network 100. The communication unit 121 can perform communications with the print management apparatus 130 via the network 100. The PC 120 further includes an interface (IF) 122, which is functionally operable to receive user processing. For example, the IF 122 can receive user processing having been input via a keyboard or a pointing device (e.g., a mouse, a touch panel, or the like) on a screen displayed on a display device.

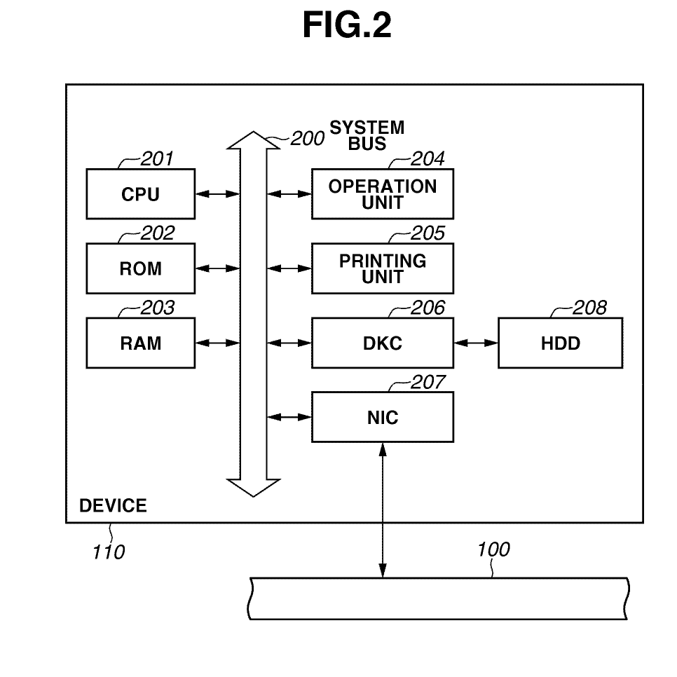

FIG. 2 is a block diagram illustrating an example of a hardware configuration of the device 110. In FIG. 2, a central processing unit (CPU) 201 can output an image signal, as output information, to a printing unit (i.e., a printer engine) 205 connected via a system bus 200 based on a control program.

The control program is stored in a computer-readable storage medium, such as a read only memory (ROM) 202 or a hard disk drive (HDD) 208. The CPU 201 can access the HDD 208 via a disk controller (DKC) 206.

A network interface card (NIC) 207 enables the CPU 201 to perform communication processing with a computer accessible via the network 100. A random access memory (RAM) 203 is functionally operable as a main memory or a work area for the CPU 201.

An operation unit 204 includes switches, a light-emitting diode (LED) display device, and a touch panel attached display device, which enable users to input operational instructions. The printing unit 205 can perform printing on a sheet or a paper according to an appropriate printing method, such as an electrophotographic print method, an inkjet method, or a sublimation method.

To realize the functions of the device 110 (including the functions of the data processing unit 111, the printing unit 112, the communication unit 113, and the IF 114) illustrated in FIG. 1, the CPU 201 can execute a computer-readable program when it is loaded from the ROM 202 and control the functional components illustrated in FIG. 2.

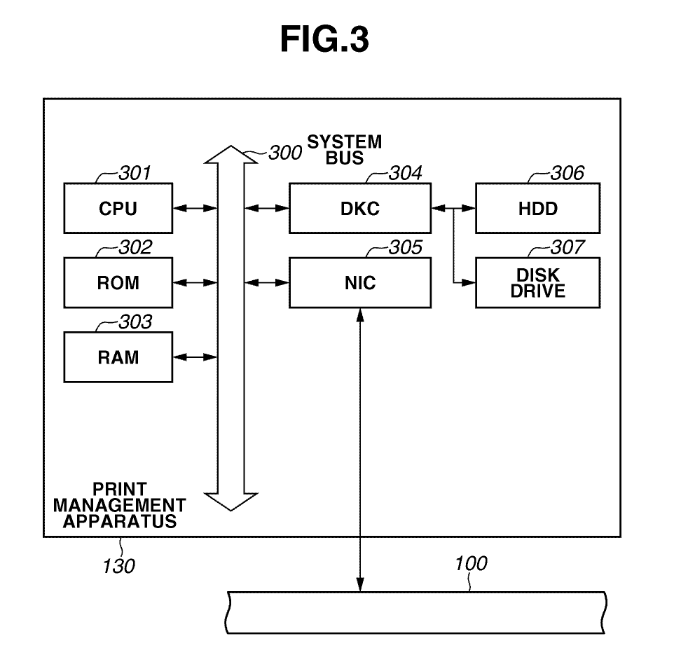

FIG. 3 is a block diagram illustrating an example of a hardware configuration of the print management apparatus 130. In FIG. 3, a CPU 301 can execute a (computer-readable) program loaded into a RAM 303 (i.e., a work memory) from a ROM 302 or a HDD 306 to control each constituent component via a system bus 300.

The HDD 306 stores an operating system (OS) in addition to various programs and data. The CPU 301 can access the HDD 306 and a disk drive 307 via a disk controller (DKC) 304 and installs various programs on the HDD 306.

A network interface card (NIC) 305 enables the CPU 301 to communicate with other computers and devices accessible via the network 100.

To realize the functions of the print management apparatus 130 (including the functions of the data processing unit 131, the communication unit 132, and the data storage unit 133) illustrated in FIG. 1, the CPU 301 of the print management apparatus 130 can execute a computer-readable program when it is loaded from the ROM 302 or the HDD 306 and control the functional components illustrated in FIG. 3.

The PC 120 has a configuration similar to that of the print management apparatus 130, although the PC 120 includes a display device, a keyboard, and a pointing device. Further, the PC 120 includes a NIC that enables the PC 120 to communicate with an external device accessible via the network 100.

To realize the functions of the PC 120 (including the functions of the communication unit 121 and the IF 122) illustrated in FIG. 1, the CPU 301 of the PC 120 can execute a computer-readable program when it is loaded from the ROM 302 or the HDD 306 and control the functional components illustrated in FIG. 3.

Hereinafter, example processing for determining print settings in the pull print is described in detail below. The system according to the present exemplary embodiment can be realized by a cooperative operation of software programs running on a plurality of information processing apparatuses (such as the print management apparatus 130 and the device 110). The above-described programs are computer-readable programs that can be stored in a nonvolatile storage area of respective information processing apparatuses, and can be executed by the CPU when loaded into the RAM.

First, an example procedure for uploading a print target document from an external apparatus (e.g., the PC 120) to the print management apparatus 130 according to the present exemplary embodiment is described below.

If a user inputs a document upload instruction via the IF 122, the PC 120 transmits a document to the print management apparatus 130 via the communication unit 121. The document transmitted in this case from the PC 120 to the print management apparatus 130 has a data format, such as Portable Document Format (PDF) or Enhanced Metafile (EMF), which is not dependent on the device.

Further, the document data to be transmitted to the print management apparatus 130 can be scanned data obtained by an image forming apparatus. In this case, performing an upload request for the data directly from an image forming apparatus is feasible.

It is useful to add user information indicating a user who is allowed to print a document and print setting information (e.g., page aggregation) when a document is uploaded. Further, the user information (indicating the user who is allowed to print a document) can be designated manually by a user when the uploading is executed, or can be designated automatically to allow only the user who has instructed the uploading to perform printing.

When the print management apparatus 130 receives a document via the communication unit 132, the data processing unit 131 converts the document based on print settings if print setting information is added to the received job. Further, the data processing unit 131 stores the document itself and document information (e.g., the print setting information) in the data storage unit 133.

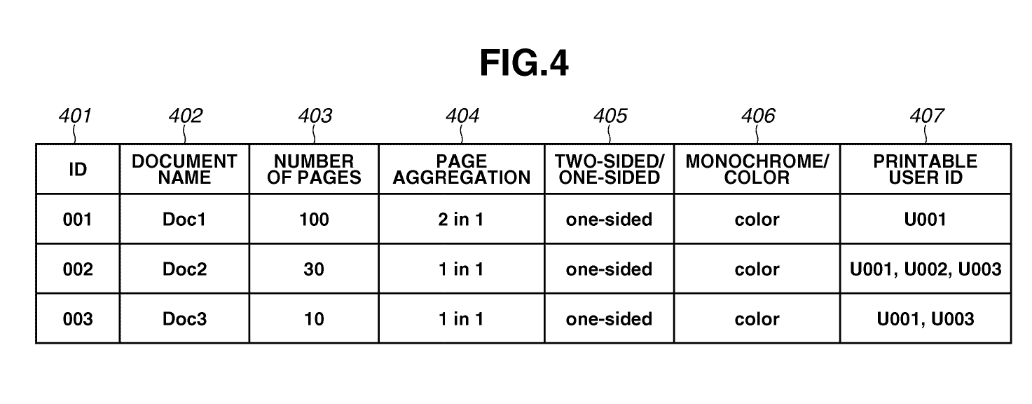

FIG. 4 illustrates an example of a table that stores the document information. The table illustrated in FIG. 4 can be stored in the data storage unit 133 of the print management apparatus 130.

As illustrated in FIG. 4, the document information mutually associated and stored in the table includes ID 401, document name 402, number of pages 403, page aggregation setting 404, two-sided/one-sided setting 405, monochrome/color setting 406, and printable user ID setting 407. The ID 401 is identification information to be allocated to each document by the data processing unit 131 of the print management apparatus 130.

According to the example illustrated in FIG. 4, the document having a document name “Doc1” includes page aggregation setting (e.g., 2 in 1 setting in this case) having been set in the upload processing.

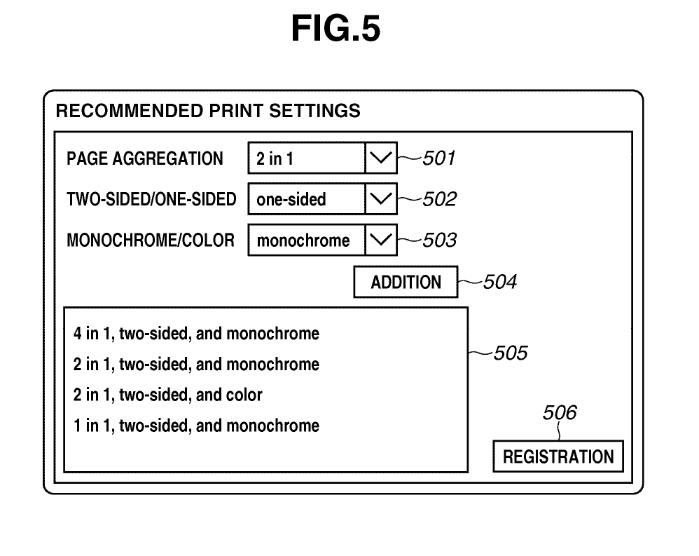

The processing to be performed according to the present exemplary embodiment includes recommended print settings, as described below. An administrator requests the print management apparatus 130 to transmit a setting screen of recommended print settings, via a web browser of an administrator's PC (not illustrated). In response to the administrator's request, the print management apparatus 130 sends a recommended print setting screen illustrated in FIG. 5 to the web browser of the administrator's PC.

FIG. 5 illustrates an example of the recommended print setting screen. As illustrated in FIG. 5, an appropriate combination of page aggregation setting information, two-sided/one-sided setting information, and monochrome/color setting information can be generated as recommended print settings. The print setting items to be included in the recommended print settings are not limited to the above-described examples. For example, the recommended print settings can additionally include any print/appearance related setting items, such as toner saving settings (i.e., setting to limit the usage amount of toner) and staple usage setting.

The recommended print setting screen illustrated in FIG. 5 includes an aggregation setting field 501, a two-sided/one-sided setting field 502, and a monochrome/color setting field 503. The recommended print settings can be generated as a combination of setting data (page aggregation setting, two-sided/one-sided setting, and monochrome/color setting) selected in the setting fields 501 to 503. The print setting items to be included in the recommended print settings are not limited to the above-described examples. For example, the recommended print settings can additionally include any print/appearance related setting items, such as toner saving settings and staple usage settings.

Further, it is feasible to generate a plurality of recommended print settings. If a user presses an addition button 504, an additional combination of setting data selected in the fields 501 to 503 can be displayed in a field 505 as new recommended print settings. The plurality of recommended print settings added in the field 505 are referred to as a set of recommended print settings.

According to the screen illustrated in FIG. 5, the administrator has taken the following combinations (1) to (4) into consideration to generate the recommended print settings.
(1) 4 in 1, two-sided, and monochrome
(2) 2 in 1, two-sided, and monochrome
(3) 2 in 1, two-sided, and color
(4) 1 in 1, two-sided, and monochrome
   The recommended print settings can be set for each of the users who perform printing or for each of user rights. For example, in a general company, it is useful to differentiate a set of recommended print settings to be generated for an employee from a set of recommended print settings to be generated for a manager.

Further, it is useful to provide an upper-limit value of the emission amount of greenhouse effect gas (e.g., carbon dioxide emissions) for each user. In this case, the recommended print settings can be determined according to a ratio of the cumulative result to the upper-limit value. Further, it is useful to determine the recommended print settings for each condition. In the present exemplary embodiment, an example of the greenhouse effect gas is carbon dioxide (CO2).

For example, when the cumulative result relative to the upper limit of the carbon dioxide emissions can be classified into a plurality of ranges of “less than 50%”, “50% to 100%”, and “greater than upper-limit value”, it is useful to determine the recommended print settings for each range considering the severity of carbon dioxide emissions. More specifically, when there are four types of available recommended print settings (1) to (4) as described above, it is useful to permit the usage of all recommended print settings (1) to (4) if the rate of the cumulative result is less than 50%. Further, it is useful to permit the usage of three recommended print settings (1) to (3) if the rate of the cumulative result is in the range from 50% to 100%, and only one recommended print settings (1) if the rate of the cumulative result exceeds the upper-limit value.

According to the above-described configuration, it is useful to provide a conditions setting field beneath the monochrome/color setting field 503 of the recommended print setting screen illustrated in FIG. 5 to enable users to select one of the conditions “nothing”, “less than CO2 upper limit”, and “less than 50% of CO2 upper limit.”

Further, according to the above-described configuration, the print management apparatus 130 stores the upper-limit value and the cumulative result with respect to carbon dioxide emissions for each user in the data storage unit 133. The administrator can input the upper-limit value of carbon dioxide emissions for each user via the setting screen that can be provided by the print management apparatus 130.

Further, the print management apparatus 130 can acquire a print result (e.g., information indicating print settings selected by a user and the number of sheets used for the print) from the device, and can calculate carbon dioxide emissions, as a result value, for each user based on the acquired print result. The print management apparatus 130 adds the calculated value to the cumulative result corresponding to the user stored in the data storage unit 133. It is useful to clear the cumulative result corresponding to each user when a predetermined time (e.g., a month) has elapsed.

More specifically, the cumulative result for each user corresponds to a cumulative value of the information indicating an impact on the environment caused by user's printing operations during a predetermined period of time (e.g., during a month), such as the amount of carbon dioxide emissions. As an example method, the print management apparatus 130 can periodically acquire a print result from the device. Alternatively, the device can send a notification to the print management apparatus 130 every time when the device has completed the print processing.

According to the configuration in the above-described embodiment, the upper-limit value and the cumulative result are setting values to be set for each user. However, it is useful to provide the upper-limit value and the cumulative result for each group including a plurality of users or for each division of a company in determining the usability of respective recommended print settings.

To calculate the amount of carbon dioxide emissions, the print management apparatus 130 stores fundamental data indicating the amount of carbon dioxide emissions caused when a document is printed using predetermined print settings for each device type or the amount of carbon dioxide emissions caused when consumable supplies (such as sheets) are produced. The above-described fundamental data relating to the amount of carbon dioxide emissions can be collectively referred to as “carbon dioxide emission information.” The carbon dioxide emission information can be stored beforehand in the data storage unit 133. The print management apparatus 130 calculates the amount of carbon dioxide emissions based on the carbon dioxide emission information and a print result.

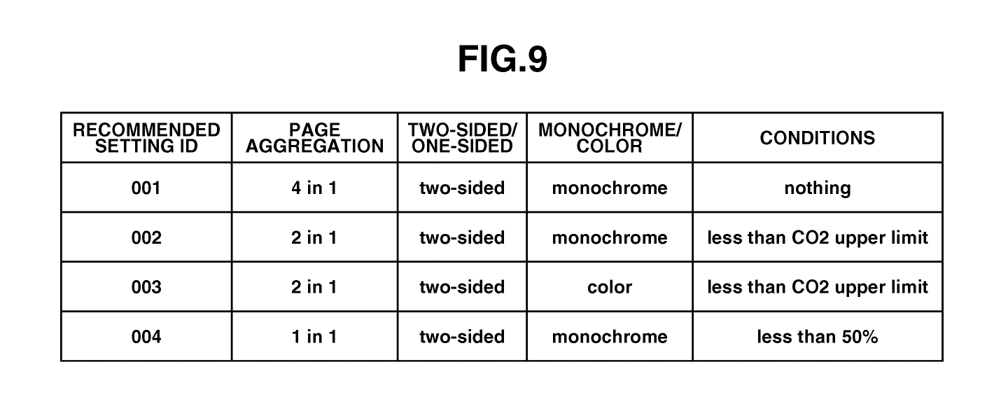

If a registration button 506 is pressed on the recommended print setting screen illustrated in FIG. 5, the data processing unit 131 of the print management apparatus 130 stores a set of recommended print settings currently displayed in the field 505 in the data storage unit 133. For example, a set of recommended print settings illustrated in FIG. 9 can be stored in the data storage unit 133.

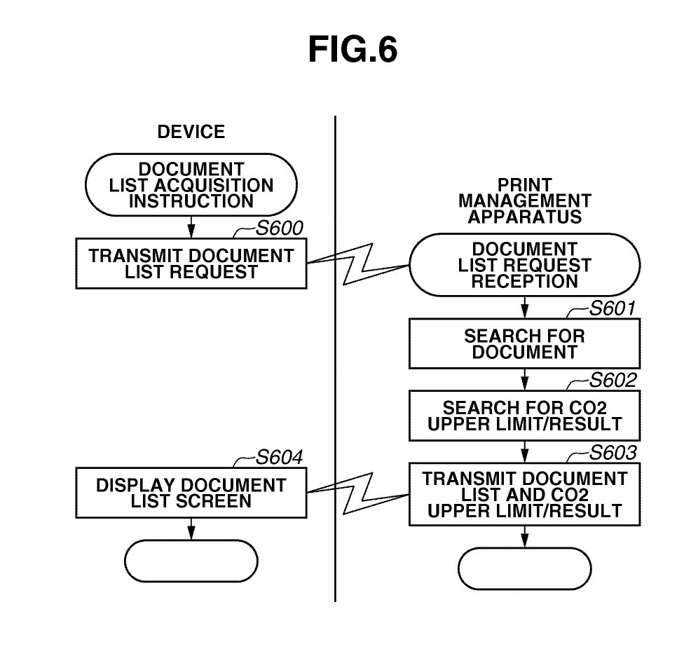

Next, an example of processing according to the present exemplary embodiment, which can be performed when the device 110 acquires a document list stored in the print management apparatus 130, is described with reference to a flowchart illustrated in FIG. 6.

FIG. 6 is a flowchart illustrating an example of processing that can be performed by the print management apparatus 130 when the device 110 acquires a document list from the print management apparatus 130. The data processing unit 111 of the device 110 executes the processing to be realized by the device 110 in the flowchart illustrated in FIG. 6. More specifically, the CPU 201 of the device 110 executes a computer-readable program when it is loaded from the ROM 202 to realize the processing to be performed by the device 110.

Further, the data processing unit 131 of the print management apparatus 130 executes the processing to be realized by the print management apparatus 130. More specifically, the CPU 301 of the print management apparatus 130 executes a computer-readable program when it is loaded from the ROM 302 or the HDD 306 to realize the processing to be performed by the print management apparatus 130.

First, if a user wants to print a document stored in the print management apparatus 130, the user operates the IF 114 of the device 110 to log in the device 110. The IF 114 of the device 110 can provide an appropriate means or device that enables users to acquire a document list stored in the print management apparatus 130. For example, the IF 114 can include a button to enable each user to press the button to acquire a document list.

If the data processing unit 111 of the device 110 receives a document list acquisition instruction, then in step S600, the data processing unit 111 sends a request for a document list to the print management apparatus 130 via the communication unit 113. In this case, the data processing unit 111 sends identification information of the user who is currently logging on the device 110 to the print management apparatus 130.

If the print management apparatus 130 has received a document list acquisition request, then in step S601, the data processing unit 131 executes processing for searching for a document stored in the data storage unit 133. In this case, the data processing unit 131 searches for all documents that the user can print with reference to the identification information received from the device 110. Then, the data processing unit 131 generates a list of the printable documents (i.e., the requested document list).

Next, in step S602, the data processing unit 131 searches for an upper-limit value and a cumulative result with respect to carbon dioxide emissions by the user, which are stored in the data storage unit 133. Then, in step S603, the print management apparatus 130 transmits the above-described search results (i.e., the document list as well as the upper-limit value and the cumulative result with respect to the carbon dioxide emissions) obtained in steps S601 and S602 to the device 110. The processing performed in step S603 is referred to as “first transmission processing.”

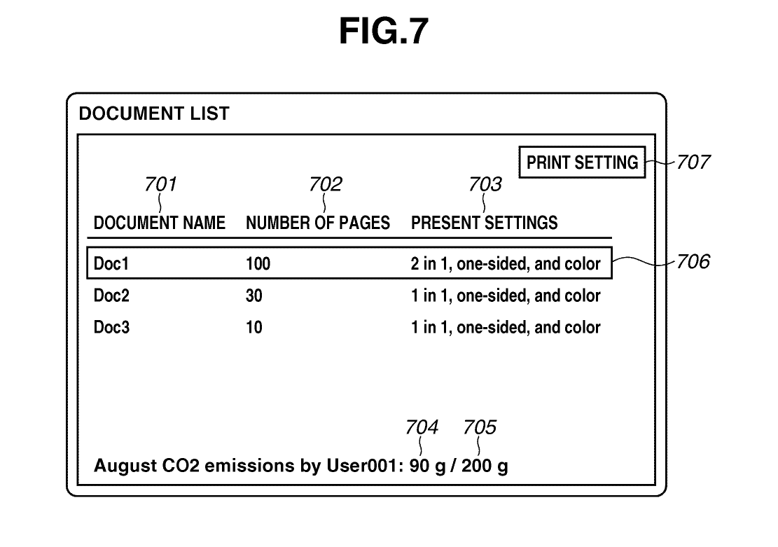

The data processing unit 111 of the device 110 receives the information (search results) transmitted from the print management apparatus 130 in step S603. In other words, the data processing unit 111 performs list acquisition processing. Then, in step S604, the data processing unit 111 causes the IF 114 to display a screen including the received information as illustrated in FIG. 7.

FIG. 7 illustrates an example of a document list screen displayed on the IF 114 of the device 110 according to a first exemplary embodiment.

The document list screen illustrated in FIG. 7 includes a list of document information including document name 701, number of pages 702, and present setting information 703. The present setting information 703 can be displayed if print settings are designated beforehand in the uploading of a document. For example, according to the example illustrated in FIG. 7, the information relating to a document “Doc1” includes a page aggregation setting item (i.e., “2 in 1”).

Further, the document list screen includes information indicating an upper-limit value 705 and a cumulative result 704 with respect to the carbon dioxide emissions by each user. The document list screen further includes a print setting button 707. If an operator selects any one of the documents in the document list displayed in a field 706 and presses the print setting button 707, the print settings of the selected document can be changed.

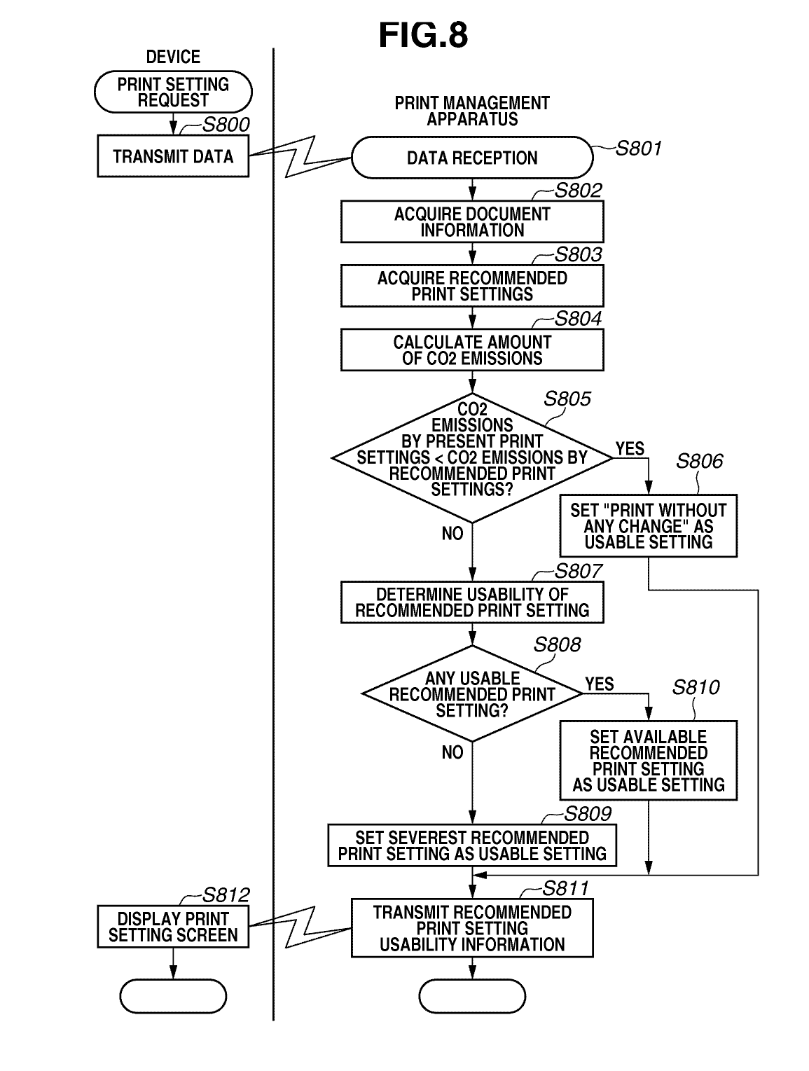

Next, example processing for displaying recommended print settings according to the present exemplary embodiment is described with reference to a flowchart illustrated in FIG. 8.

FIG. 8 is a flowchart illustrating an example of the processing for displaying recommended print settings according to the first exemplary embodiment. The data processing unit 111 of the device 110 executes the processing to be realized by the device 110 in the flowchart illustrated in FIG. 8. More specifically, the CPU 201 of the device 110 executes a computer-readable program when it is loaded from the ROM 202 to realize the processing to be performed by the device 110.

Further, the data processing unit 131 of the print management apparatus 130 executes the processing to be realized by the print management apparatus 130. More specifically, the CPU 301 of the print management apparatus 130 executes a computer-readable program when it is loaded from the ROM 302 or the HDD 306 to realize the processing to be performed by the print management apparatus 130.

In the present exemplary embodiment, it is presumed that contents illustrated in FIG. 9 are set beforehand as recommended print settings.

FIG. 9 illustrates an example of the set of recommended print settings that can be stored in the data storage unit 133 of the print management apparatus 130. The example illustrated in FIG. 9 corresponds to a set of recommended print settings, in which contents of usable recommended print settings are variable according to a ratio of the emission result to the upper limit of carbon dioxide emissions.

More specifically, according to the example illustrated in FIG. 9, if the emission result is less than 50% of the upper limit of carbon dioxide emissions, all of recommended print settings ID 001 to ID 004 are available. Further, if the emission result is in a range from 50% to 100% of the upper limit of carbon dioxide emissions, three recommended print settings ID 001 to ID 003 are available. Further, if the emission result exceeds the upper limit, only one recommended print settings ID 001 is available.

The user can select a document to be printed from the document list screen illustrated in FIG. 7, which is displayed on the IF 114. The example illustrated in FIG. 7 indicates a selected state of the document Doc1 (see a line 706). If the user wants to finalize the selection, the user can press the print setting button 707. In response to the instruction using the print setting button 707, the device 110 receives a recommended print setting acquisition instruction (i.e., a print setting request).

In step S800, the device 110 transmits the identification information (ID 401) of the selected document, identification information (user ID) of a user who is currently logging on the device 110, and device type identification information, via the communication unit 113, to the print management apparatus 130. In step S801, the data processing unit 131 of the print management apparatus 130 receives the information transmitted from the device 110 in step S800, via the communication unit 132.

The data processing unit 131 of the print management apparatus 130 compares the information received in step S801 with the set of recommended print settings and the carbon dioxide emission information stored in the data storage unit 133. Thus, the data processing unit 131 determines presently usable recommended print settings.

First, in step S802, the data processing unit 131 searches for the document stored in the data storage unit 133 with reference to the document identification information received in step S801. Then, the data processing unit 131 acquires document information.

Next, in step S803, the data processing unit 131 searches for the recommended print settings stored in the data storage unit 133.

Next, in step S804, the data processing unit 131 calculates an estimated amount of carbon dioxide emissions in a case where the document is directly printed, based on the device type identification information and the document information received in step S801 as well as based on the carbon dioxide emission information stored in the data storage unit 133. Similarly, the data processing unit 131 calculates an estimated amount of carbon dioxide emissions and an estimated reduction amount in a case where the document is printed according to the recommended print setting information acquired in step S803.

Further, the data processing unit 131 calculates an estimated amount of carbon dioxide emissions and an estimated reduction amount in a case where the document is printed according to the present print settings. In the present exemplary embodiment, the technical terminology “reduction amount” indicates a reduced amount of carbon dioxide emissions compared to the amount of carbon dioxide emissions in a case where the document is printed according to default settings (including no special print settings). The amount of carbon dioxide emissions can be calculated considering, for example, the number of sheets to be used in printing or electric power consumption during print processing. The amount of carbon dioxide emissions may be variable depending on the type of a printing device.

Next, in step S805, the data processing unit 131 determines whether the estimated amount of carbon dioxide emissions according to the present print settings is smaller than the smallest estimated amount of carbon dioxide emissions according to the recommended print settings as a calculation result in step S804.

If it is determined that the estimated amount of carbon dioxide emissions according to the present print settings is smaller than the smallest estimated amount of carbon dioxide emissions according to the recommended print settings (Yes in step S805), then in step S806, the data processing unit 131 determines only the setting item “print without any change” as being usable. More specifically, the data processing unit 131 generates usability information indicating that only the setting item “print without any change” is usable and all of the recommended print settings are unusable.

In the present exemplary embodiment, the usability information includes information indicating the amount of carbon dioxide emissions and the reduction amount in a case where the selected document is printed according to the usable print setting (i.e., the setting item “print without any change” in the above-described case). Then, the processing proceeds to step S811.

On the other hand, if it is determined that the estimated amount of carbon dioxide emissions according to the present print settings is not smaller than the smallest estimated amount of carbon dioxide emissions according to the recommended print settings (No in step S805), then in step S807, the data processing unit 131 determines whether each set of recommended print settings is usable.

An example of the processing for determining the usability (usage permission) for each of the recommended print settings is described in detail below.

For example, with respect to the carbon dioxide emissions, it is now presumed that the upper-limit value set for a log-on user of the device 110 is 200 g and the present cumulative result is 90 g. Further, as a calculation result in step S804, the amount of carbon dioxide emissions according to the recommended print settings ID 001 is equal to 7 g. The amount of carbon dioxide emissions according to the recommended print settings ID 002 is equal to 8 g. The amount of carbon dioxide emissions according to the recommended print settings ID 003 is equal to 9 g. The amount of carbon dioxide emissions according to the recommended print settings ID 004 is equal to 12 g.

In this case, even if the calculated CO2 value corresponding to the recommended print settings ID 001 to ID 003 is added to the present cumulative result (=90 g), the rate of the cumulative result does not exceed 50% of the upper-limit value. However, if the calculated CO2 value corresponding to the recommended print settings ID 004 is added to the present cumulative result (=90 g), the rate of the cumulative result exceeds 50% of the upper-limit value.

In this case, with reference to the conditions illustrated in FIG. 9, it is determined that the recommended print settings ID 004 cannot be used when the rate of the cumulative result exceeds 50%. Therefore, in step S807, the data processing unit 131 determines that the recommended print settings ID 001 to ID 003 are usable.

In the present exemplary embodiment, the device type information is taken into consideration in determining the usability of recommended print settings. If there are any recommended settings that cannot be realized (e.g., when the device does not have a two-sided function), the recommended settings are determined as being unusable.

Further, if usable print settings are changed depending on the presence of a finisher or any other optional equipment associated with the device, the device 110 can transmit device configuration information together with the device type information in step S800. Alternatively, the device configuration information can be stored in the print management apparatus 130 beforehand.

Further, the determination whether each setting item included in the recommended print settings is more severe than the corresponding item of the present print settings is performed. The print settings are determined as being “severe”, for example, if the amount of carbon dioxide emissions is small. If the recommended settings include any one setting item that is not more severe than the corresponding item of the present print settings, the recommended settings are determined as being unusable.

For example, if a document includes the setting item “4 in 1”, it is determined that the recommended settings including the setting item “2 in 1” are unusable. If a document includes the setting item “4 in 1”, it is determined that the recommended settings including the setting item “4 in 1” is selectable.

If the setting item “4 in 1” is included in the selected recommended settings for a document that already includes the setting item “4 in 1”, the printing is performed according to the setting item “4 in 1.” The document is not further subjected to the page aggregation according to the setting item “4 in 1.”

Next, in step S808, the data processing unit 131 determines whether there is at least one usable recommended setting based on the result of step S807 in which the usability has been checked for all recommended print settings. If it is determined that there is not any usable recommended setting (No in step S808), then in step S809, the data processing unit 131 sets the severest recommended print settings having the smallest amount of carbon dioxide emissions as usable settings.

More specifically, the data processing unit 131 generates usability information indicating that only the severest recommended print settings are usable and the setting item “print without any change” is unusable.

In this case, the usability information includes information indicating the amount of carbon dioxide emissions and the reduction amount in a case where the selected document is printed according to the usable print settings (i.e., the severest recommended print settings in the above-described case). Then, the processing proceeds to step S811.

On the other hand, if it is determined that at least one set of usable recommended settings is present (Yes in step S808), then in step S810, the data processing unit 131 sets only the available recommended settings as usable settings.

More specifically, the data processing unit 131 generates usability information indicating that only the available recommended print settings are usable (i.e., the usage thereof is permitted) and other recommended print settings and the setting item “print without any change” are unusable. In this case, the usability information includes information indicating the amount of carbon dioxide emissions and the reduction amount in a case where the selected document is printed according to the usable print setting.

The processing next proceeds to step S811. The data processing unit 131 can execute the above-described processing of step S807 for the setting item “print without any change.” If it is determined that the setting item “print without any change” is usable, the data processing unit 131 can set the setting item “print without any change” as an usable setting item.

In step S811, the data processing unit 131 transmits the set of recommended print settings together with the above-described usability information generated in step S806, S809, or S810 to the device 110. The processing performed in step S811 is referred to as “second transmission processing.”

Further, in step S811, the data processing unit 131 can transmit information indicating the amount of carbon dioxide emissions in a case where the printing is performed according to the usable recommended print settings (i.e., the usage permitted setting included in the above-described usability information) and information indicating the reduction amount of carbon dioxide emissions in comparison with the printing performed without applying any recommended print settings, to the device 110. The processing performed in step S811 in this case is referred to as “third transmission processing.”

Further, in step S811, the data processing unit 131 transmits the document acquired in step S802 to the device 110. The processing performed in step S811 in this case is referred to as “fourth transmission processing.” It is useful to transmit the document in response to a print instruction.

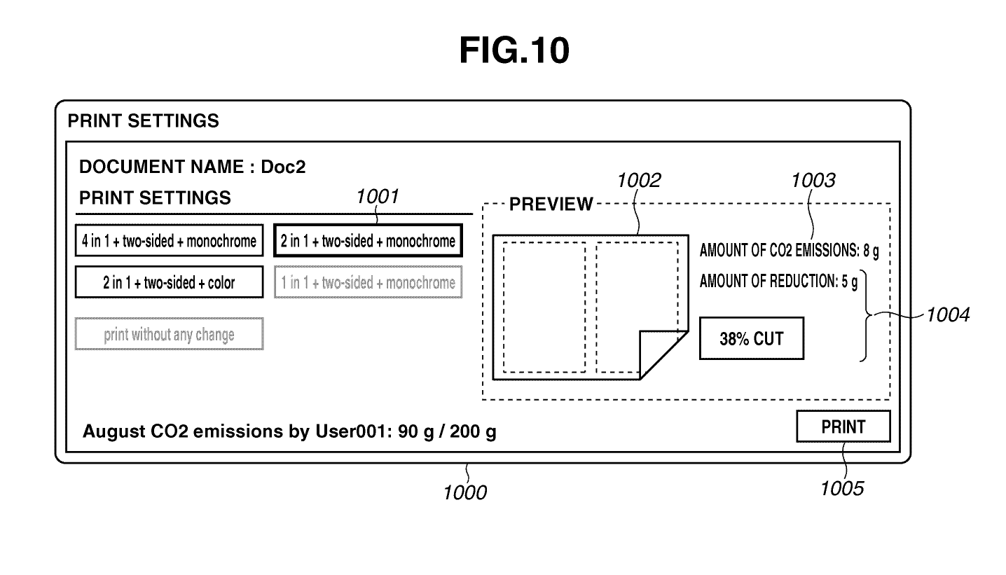

In step S812, the data processing unit 111 of the device 110 receives the set of recommended print settings and the usability information of the set of recommended print settings transmitted from the print management apparatus 130 instep S811. The processing performed in step S812 is referred to as “setting acquisition processing.” The data processing unit 111 displays a print setting screen 1000 illustrated in FIG. 10 on the IF 114 based on the usability information of the set of recommended print settings.

Further, in step S812, the data processing unit 111 receives the information indicating the amount of carbon dioxide emissions in a case where the printing is performed according to the usable recommended print settings (i.e., the usage permitted setting included in the above-described usability information) and the information indicating the reduction amount of carbon dioxide emissions in comparison with the printing performed without applying any recommended print settings, from the print management apparatus 130. The processing performed in step S812 is referred to as “environmental impact acquisition processing.”

Further, in step S812, the data processing unit 111 receives the document that corresponds to the document identification information transmitted to the print management apparatus 130 in step S800, from the print management apparatus 130. The processing performed in step S812 in this case is referred to as “data acquisition processing.”

FIG. 10 illustrates an example of the print setting screen according to the first exemplary embodiment.

The data processing unit 111 controls the display of the print setting screen in such a way as to enable users to select only the available recommended print settings (i.e., the usage permitted settings included in the usability information) among the set of recommended print settings acquired in step S812 of the flowchart illustrated in FIG. 8.

According to the example illustrated in FIG. 10, three recommended print settings “4 in 1+two-sided+monochrome”, “2 in 1+two-sided+monochrome”, and “2 in 1+two-sided+color” are selectable, and two recommended print settings “1 in 1+two-sided+monochrome” and “print without any change” are not selectable. Further, the example illustrated in FIG. 10 indicates a selected state of the recommended print settings “4 in 1+two-sided+monochrome” as illustrated in a field 1001).

If the button corresponding to the usable recommended print settings (e.g., “4 in 1+two-sided+monochrome”) is pressed, the data processing unit 111 displays a preview 1002 of a print result according to the selected print settings together with information indicating the amount of carbon dioxide emissions 1003 for the print processing, and the reduction amount 1004 (i.e., the information indicating the reduction amount of carbon dioxide emissions in comparison with the printing performed without applying any recommended print settings), on the print setting screen.

The reduction amount calculation is displayed as a comparison result compared to a case where printing is performed without using any print settings to prevent the CO2 reduction amount of a document from being estimated to be lower if print settings are set beforehand when the document is uploaded.

Further, the preview 1002 according to the present exemplary embodiment is a print preview image that allows users to check an output image when printing is performed according to the selected print settings. The preview 1002 is not the one generated from actual print data, and can be generated from actual print data.

When a print button 1005 is pressed by a user, the data processing unit 111 of the device 110 instructs the printing unit 112 to execute printing of the document (i.e., the document received in step S812) selected from the document list according to the selected print settings. In response to the instruction, the printing unit 112 prints the above-described document according to the above-described selected print settings.

Then, if the print processing is completed, the data processing unit 111 of the device 110 transmits the print result to the print management apparatus 130. The data processing unit 131 of the print management apparatus 130 updates the result of the carbon dioxide emissions based on the print result received from the device 110. More specifically, the data processing unit 111 updates the result stored in the data storage unit 133 by adding the amount of carbon dioxide emissions corresponding to the newly executed print to the result stored in the data storage unit 133.

When the determination result is “Yes” in step S805 illustrated in FIG. 8, more specifically, if it is determined that the amount of carbon dioxide emissions according to the present settings is smaller than the amount of carbon dioxide emissions according to the severest recommended print settings (i.e., the settings having the smallest amount of carbon dioxide emissions), only the setting item “print without any change” is set to be usable.

However, when the determination result is “Yes” in step S805 illustrated in FIG. 8, it is useful to determine the usability of respective recommended print settings (like the processing described in step S807). In this case, it is useful to determine not only the setting item “print without any change” but also the usable recommended print settings as being usable.

Further, in the present exemplary embodiment, instead of referring to the emission amount of greenhouse effect gas (CO2), it is useful to refer to print charges or the total number of printed sheets in determining the usability of recommended print settings. Further, it is useful to notify users of the upper-limit value and the cumulative result with respect to the emission amount of greenhouse effect gas, as information indicating an impact on the environment to be displayed on a document list display screen or the print setting screen, together with the print charges or the total number of printed sheets (the number of used print sheets).

In this case, it may be useful to display estimated print charges and printed sheets required when document printing is performed using the selected print settings, and reducible print charges and printed sheets, on the print setting screen.

Further, in the present exemplary embodiment, if there are not any usable print settings as a result of the determination with respect to the usable recommended print settings, the severest recommended print settings (i.e., the settings having the smallest amount of carbon dioxide emissions) are set to be usable, to prevent any unprintable state.

However, to realize severe print management, it may be useful to prohibit printing if there are not any usable print settings. Further, it may be useful to permit an administrator to determine whether to print if there are not any usable print settings.

In the present exemplary embodiment, the device acquires a document together with recommended print setting usability information in step S812 of the flowchart illustrated in FIG. 8. However, the device may be configured to acquire a selected document from the print management apparatus 130 if the print button 1110 is pressed.

As described above, the printing system according to the first exemplary embodiment may present recommended print settings in the pull print to enable users to perform printing operations using the settings reflecting a predetermined print policy (not the print settings determined freely by individual users), considering the impact on the environment and cost reductions, by selecting appropriate print settings presented by the device.

Accordingly, when a user of a device requests and prints data managed by a print management apparatus (i.e., a server), the user may perform flexible print operations according to user's requirements and functions of the device, within the print settings (recommended print settings) that are recommended by an administrator considering the impact on the environment and costs, with an easy and simple operation via an interface (i.e., an operation unit) of the device.

According to the above-described first exemplary embodiment, when a user presses the print setting button 707, recommended print settings are determined for one selected document.

In the present exemplary embodiment, when the device 110 acquires a document list from the print management apparatus 130, the device 110 acquires recommended print settings additionally. The present exemplary embodiment provides a configuration and a procedure that are similar to those described in the first exemplary embodiment, although detailed descriptions thereof are not repeated.

If the data processing unit 111 of the device 110 receives a document list acquisition instruction, the data processing unit 111 requests the print management apparatus 130 to transmit the document list stored in the print management apparatus 130. In this case, the device 110 according to the present exemplary embodiment transmits user identification information together with its device type identification information.

The data processing unit 131 of the print management apparatus 130 searches for documents that the user can print based on the information received from the device 110, and determines the usability of recommended print settings for respective documents according to a procedure similar to that described in the first exemplary embodiment.

More specifically, the data processing unit 131 of the print management apparatus 130 may acquire recommended print settings (like step S803 illustrated in FIG. 8), executes processing similar to the processing performed in step S802 and steps S804 to S810 illustrated in FIG. 8 on each document, and generates recommended print set usability information for each document.

Then, the data processing unit 131 of the print management apparatus 130 transmits, to the device 110, the document list, the set of recommended print settings, and recommended print set usability information relating to the set of recommended print settings for each document.

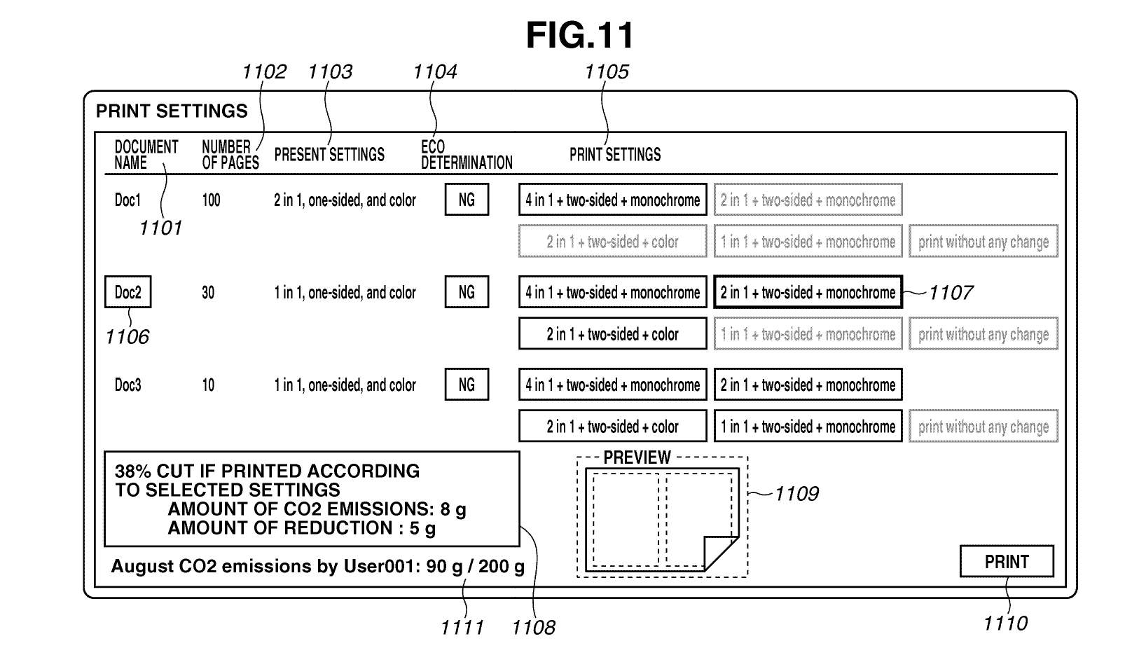

The data processing unit 111 of the device 110 receives the information transmitted from the print management apparatus 130, and displays a document list print setting screen illustrated in FIG. 11 on the IF 114 based on the received information.

FIG. 11 illustrates an example of a document list print setting screen according to the second exemplary embodiment. As illustrated in FIG. 11, the document list print setting screen according to the present exemplary embodiment includes fields of a document name 1101, number of pages 1102, present setting information 1103, ECO determination 1104, and print settings 1105, as a list of document information.

If a document is determined as being unprintable because the amount of carbon dioxide emissions according to the present settings is estimated to be great, “NG” is displayed in the field of ECO determination 1104.

In the field of the print settings 1105, only the usable recommended print settings selectable for each document are displayed. To realize the above-described display, the data processing unit 111 controls the display between “selectable” and “non-selectable” based on the information (i.e., recommended print set usability information for each document) transmitted from the print management apparatus 130.

A user selects one document to be printed (see button 1106) and presses the button indicating usable recommended print settings (see button 1107). When the button is pressed, the data processing unit 111 displays a preview 1109 (i.e., an output image obtainable if the printing is executed according to the print settings) together with additional information 1108, which includes an estimated amount of carbon dioxide emissions if the printing is executed according to the recommended print settings and a reduction amount of carbon dioxide emissions in comparison with a case where the printing is not executed according to the recommended print settings, on the print setting screen.

If a user presses the print button 1110, the data processing unit 111 of the device 110 transmits ID information of a selected document to the print management apparatus 130 and requests the print management apparatus 130 to transmit the selected document.

In response to the request, the data processing unit 131 of the print management apparatus 130 reads the document corresponding to the ID information included in the above-described request from the data storage unit 133, and transmits the readout document to the device.

The data processing unit 111 of the device 110 receives the document transmitted from the print management apparatus 130 and instructs the printing unit 112 to print the received document according to the selected print settings. When the instruction is received, the printing unit 112 prints the document according to the selected print settings.

The document list print setting screen includes information 1111 that indicates the upper-limit value and the cumulative result of carbon dioxide emissions for the user.

In the present exemplary embodiment, when the print button 1110 is pressed, the selected document is acquired from the print management apparatus 130. However, it is useful to receive all documents that correspond to a log-on user, together with a document list and a set of recommended print settings, from the print management apparatus 130.

The present exemplary embodiment may bring the effect of notifying a user of all print settings applicable to each document in the document list, in addition to the effects of the first exemplary embodiment.

In the above-described second exemplary embodiment, only one document is selected from a document list and printed. In a third exemplary embodiment, all of the documents in the document list are printable. The present exemplary embodiment provides a configuration and a procedure that are similar to those described in the first exemplary embodiment or the second exemplary embodiment, although detailed descriptions thereof are not repeated.

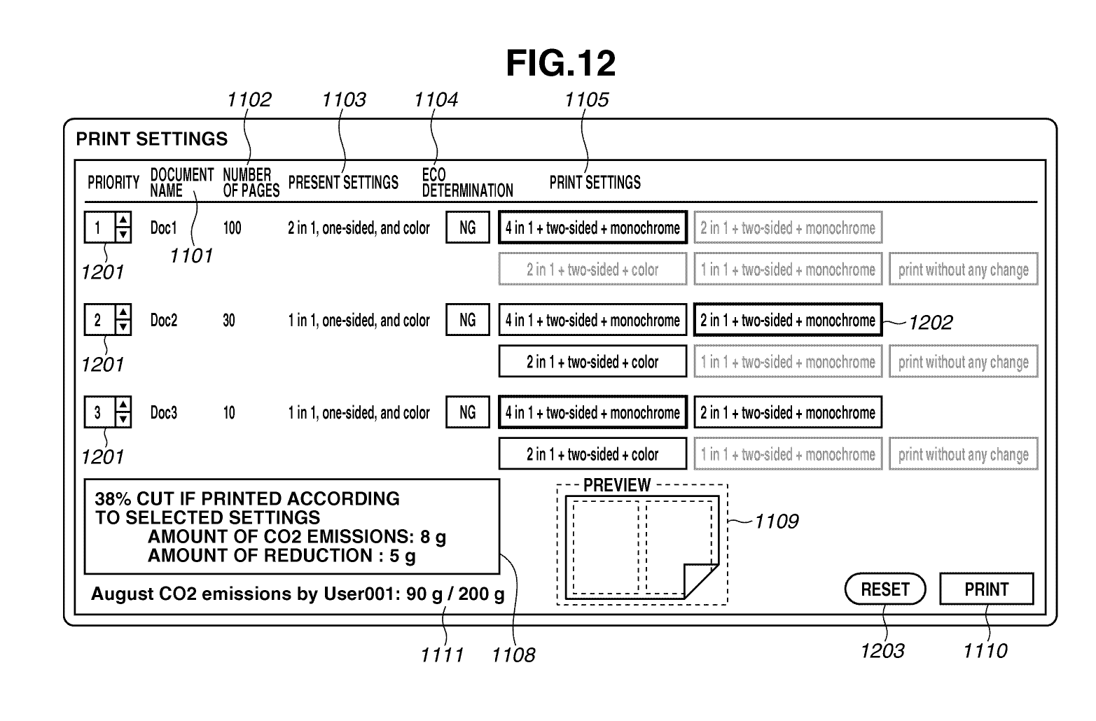

In the present exemplary embodiment, the device 110 acquires a document list according to a procedure that is similar to that described in the second exemplary embodiment. The device 110 acquires a document list, a set of recommended print settings, and recommended print settings usable to print each document, from the print management apparatus 130. Then, the device 110 displays a document list print setting screen illustrated in FIG. 12 on the IF 114 based on the acquired information.

In the present exemplary embodiment, it is presumed that the amount of carbon dioxide emissions and the reduction amount expected when each document is printed using respective recommended print settings can be acquired by the print management apparatus when respective recommended print settings are selected.

FIG. 12 illustrates an example of the document list print setting screen according to the third exemplary embodiment of the present invention. Items similar to those illustrated in FIG. 11 are denoted by the same reference numerals.

The document list print setting screen according to the present exemplary embodiment is different from that described in the second exemplary embodiment (see FIG. 11) in that a control 1201 that enables users to set a priority level for each document is provided. Each user can operate the control 1201 to set a priority level for each document.

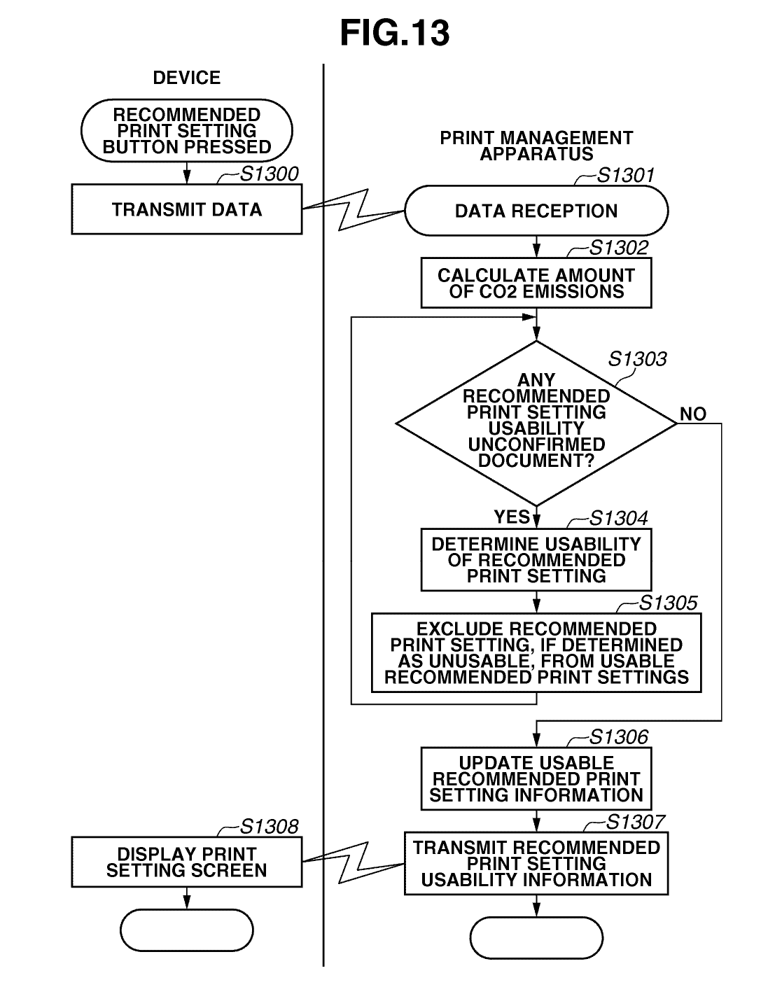

FIG. 13 is a flowchart illustrating an example of processing for changing usable recommended print settings together for a plurality of documents according to the third exemplary embodiment of the present invention. The data processing unit 111 of the device 110 executes the processing to be realized by the device 110 in the flowchart illustrated in FIG. 13. More specifically, the CPU 201 of the device 110 executes a computer-readable program when it is loaded from the ROM 202 to realize the processing to be performed by the device 110.

Further, the data processing unit 131 of the print management apparatus 130 executes the processing to be realized by the print management apparatus 130. More specifically, the CPU 301 of the print management apparatus 130 executes a computer-readable program when it is loaded from the ROM 302 or the HDD 306 to realize the processing to be performed by the print management apparatus 130. Furthermore, a non-transitory computer readable storage medium stores the computer-readable program.

A user presses a button that corresponds to desired recommended print settings (e.g., 1202) on the document list print setting screen (see FIG. 12) displayed on the IF 114.

If an instruction is received via the button that corresponds to desired recommended print settings, then in step S1300, the data processing unit 111 of the device 110 transmits selected document identification information, selected recommended print settings information, document list priority information, and presently usable recommended print settings information to the print management apparatus 130.

In step 1301, the data processing unit 131 of the print management apparatus 130 receives the information transmitted from the device 110 in step S1300. In step S1302, the data processing unit 131 calculates an estimated amount of carbon dioxide emissions and an estimated reduction amount in a case where the document corresponding to the identification information received in step S1301 is printed according to the selected recommended print settings. Then, the data processing unit 131 adds the calculated value of carbon dioxide emissions to the present cumulative result, and stores the updated cumulative result in the RAM 203.

Next, in step S1303, the data processing unit 131 determines whether there is any other print setting usability unconfirmed document. If it is determined that a print setting usability unconfirmed document is present (Yes in step S1303), the processing proceeds to step S1304.

In step S1304, the data processing unit 131 selects usable recommended print settings for a document having the highest priority level among the print setting usability unconfirmed documents, from presently usable recommended print settings, with reference to a calculation result of the present cumulative result obtained in step S1302. The data processing unit 131 can use a method similar to that described in the first exemplary embodiment to determine the usable recommended print settings.

Next, in step S1305, the data processing unit 131 excludes the recommended print settings determined as being unusable in step S1304 from the usable recommended print settings. Then, the processing returns to step S1303. The data processing unit 131 repetitively performs the above-described processing in steps S1304 and S1305 for all documents, in a descending order of a priority level of each document. If there is not any print setting usability unconfirmed document (No in step S1303), the processing proceeds to step S1306.

In step S1306, the data processing unit 131 updates usable recommended print settings information for each document based on the processing result obtained in steps S1304 to S1305.

Next, in step S1307, the data processing unit 131 transmits the usable recommended print settings information updated in step S1306 together with information relating to the carbon dioxide emissions and the reduction amount, to the device 110. In step S1308, the device 110 receives the information transmitted from the print management apparatus 130. The device 110 displays a screen that reflects the updated selectable recommended print settings on the IF 114 based on the received information. In this case, the device 110 updates the numerical data indicating the carbon dioxide emissions and the reduction amount in the field 1108.

If a user presses the print setting button 707 corresponding to each document on document list print setting screen, the device 110 and the print management apparatus 130 perform the processing of steps S1300 to S1308.

If the print setting processing is completed for all documents, the device 110 can receive a print instruction when a use presses the print button 1110. The document list print setting screen illustrated in FIG. 12 includes a reset button 1203 to enable users to change the selected recommended print settings. If the reset button 1203 is pressed, the data processing unit 111 of the device 110 returns the display state of recommended print settings to the original state where the document list is initially acquired.

If the user presses the print button 1110, the data processing unit 111 of the device 110 requests the print management apparatus 130 to transmit each document in the document list. In response to the request, the data processing unit 131 of the print management apparatus 130 reads the document corresponding to the ID information included in the above-described request from the data storage unit 133, and transmits the readout document to the device.

The data processing unit 111 of the device 110 receives all documents transmitted from the print management apparatus 130. The data processing unit 111 instructs the printing unit 112 to print received respective documents according to print settings selected for respective documents. In response to the instruction, the printing unit 112 prints each document according to the print settings selected for the document.

The present exemplary embodiment brings the effect of enabling users to select usable print settings for respective documents in a document list and print all of the documents, in addition to the effects of the first exemplary embodiment. In this case, the print settings applicable to each document can be changed appropriately according to print settings selected for another document, considering the print result.

It is useful to manage the information relating to the upper limit or the cumulative result with respect to carbon dioxide emissions for each user or for each division (or group) to which a plurality of users belong. More specifically, it is useful to determine the usability of recommended print settings with reference to the upper limit and the cumulative result having been set for each division (or group).

The device 110 can be configured to have a function comparable to that of the print management apparatus 130. More specifically, a document transmitted from the PC 120 can be stored in the HDD 208 of the device 110. The document information illustrated in FIG. 4 can be stored in the HDD 208 of the device 110.

Further, an administrator can perform recommended print settings via the IF 114 of the device 110 or the web browser of the administrator's PC to store the set of recommended print settings illustrated in FIG. 9 in the HDD 208 of the device 110. Further, the data processing unit 111 of the device 110 may be configured to execute not only the processing to be performed by the device 110 illustrated in FIG. 6, FIG. 8, and FIG. 13 but also the processing to be performed by the print management apparatus 130.

In the present exemplary embodiment, if the print button 1110 is pressed, the device 110 acquires all documents that correspond to a log-on user from the print management apparatus 130. However, the device 110 can be configured to acquire all documents together with the document list from the print management apparatus 130.

Various data are not limited to the above-described examples and can be variously changed in configuration and its contents according to the use and purpose.

The present invention is not limited to the above-described exemplary embodiment, and can be configured, for example, as a system, an apparatus, a method, a program, or a storage medium. More specifically, the present invention can be configured as a system including a plurality of devices or can be a single device. Further, the present invention encompasses any combination of the above-described exemplary embodiments.

As described above, the printing system according to the third exemplary embodiment can present recommended print settings in the pull print to enable users to perform printing operations using the settings reflecting a predetermined print policy, considering the impact on the environment and cost reductions, by selecting appropriate print settings presented by the device (with a simple operation). Then, the administrator can easily manage the impact on the environment and the costs by a print performed for each user or division, by performing upper limit setting and recommended print settings with respect to the information corresponding to the environment and the cost.

Further, the present invention can be realized by executing the following processing. That is, the processing includes supplying a software program capable of realizing the functions of the above-described exemplary embodiments to a system or an apparatus via a network or an appropriate storage medium, and causing a computer (or CPU or a micro-processing unit (MPU)) of the system or the apparatus to read and execute the program.

Further, the present invention can be applied to a system including a plurality of devices or to an apparatus constituted by a single device.

The present invention is not limited to the above-described exemplary embodiments, and can be modified in various ways within the scope of the present invention. For example, the above-described plurality of exemplary embodiments can be combined appropriately. More specifically, the present invention encompasses not only the above-described exemplary embodiments but also any modified embodiments and any combination thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-269120 filed Dec. 2, 2010, which is hereby incorporated by reference herein in its entirety.

What is claimed is:

1. A printing system including an information processing apparatus and an image forming apparatus that performs print processing of data,
wherein the information processing apparatus comprises:
a storage unit configured to store data registered by an external apparatus in association with user identification information;
a first transmission unit configured to transmit a list of the stored data, which corresponds to user identification information transmitted from the image forming apparatus, to the image forming apparatus;
a calculation unit configured to calculate information indicating an impact on the environment if the image forming apparatus performs printing of the data included in the list, using a plurality of print settings registered beforehand;
a determination unit configured to determine one or a plurality of print settings that can be used in the printing of the data included in the list, based on a calculation result obtained by the calculation unit;
a second transmission unit configured to transmit the usable one or the plurality of print settings determined by the determination unit to the image forming apparatus;
a third transmission unit configured to transmit the information indicating the impact on the environment calculated by the calculation unit to the image forming apparatus; and
a fourth transmission unit configured to transmit the data included in the list to the image forming apparatus,
wherein the image forming apparatus comprises:
a list acquisition unit configured to transmit identification information of a user who is currently operating the image forming apparatus to the information processing apparatus in response to an instruction received via an operation unit, and acquire a list of data that correspond to the user identification information from the information processing apparatus;
a display unit configured to display the list of the data acquired by the list acquisition unit;
a setting acquisition unit configured to acquire one or a plurality of print settings usable for printing from the information processing apparatus;
a environmental impact acquisition unit configured to acquire information indicating an impact on the environment if printing of the data included in the list is performed using the one or the plurality of print settings acquired by the setting acquisition unit, from the information processing apparatus;
a presenting unit configured to perform a presentation to enable users to select an appropriate one or a plurality of the print settings acquired by the setting acquisition unit;
a data acquisition unit configured to acquire the data included in the list from the information processing apparatus; and
a printing unit configured to perform print processing on the data acquired by the data acquisition unit using appropriate print settings selected from the print settings presented by the presenting unit in response to a print instruction received via the operation unit,
wherein the presenting unit is configured to display the information indicating the impact on the environment acquired by the environmental impact acquisition unit, in accordance with the selection of the print settings, to indicate an evaluation value corresponding to the selected print settings.

2. An image forming apparatus that performs print processing of data, comprising:
a list acquisition unit configured to transmit identification information of a user who is currently operating the image forming apparatus to an information processing apparatus in response to an instruction received via an operation unit, and acquire a list of data that correspond to the user identification information from the information processing apparatus;
a display unit configured to display the list of the data acquired by the list acquisition unit;
an environmental impact acquisition unit configured to acquire information indicating an impact on the environment if printing of the data included in the list is performed using one or a plurality of usable print settings;
a presenting unit configured to perform a presentation to enable users to select an appropriate one or a plurality of print settings acquired by the setting acquisition unit;
a data acquisition unit configured to acquire the data included in the list from the information processing apparatus; and
a printing unit configured to perform print processing on the data acquired by the data acquisition unit using appropriate print settings selected from the print settings presented by the presenting unit according to a print instruction received via the operation unit,
wherein the presenting unit is configured to present the information indicating the impact on the environment acquired by the environmental impact acquisition unit, in accordance with the selection of the print settings, to indicate an evaluation value corresponding to the selected print settings.

3. The image forming apparatus according to claim 2, wherein the information indicating the impact on the environment includes at least one of the emission amounts of greenhouse effect gas and the usage number of print sheets.

4. The image forming apparatus according to claim 2,
wherein the image forming apparatus calculates information indicating an impact on the environment if printing of the data included in the list is performed according to a plurality of print settings registered beforehand in the information processing apparatus, and determines the usability of respective registered print settings with reference to the calculation results and a comparison between a predetermined upper-limit value and a cumulative value of the information indicating the impact on the environment by a print that the user has performed during a predetermined period of time, and
wherein the usable one or a plurality of print settings are settings determined as usable among the registered plurality of print settings.

5. The image forming apparatus according to claim 2,
wherein the image forming apparatus determines the usability of a plurality of print settings registered beforehand in the information processing apparatus in accordance with function information of the image forming apparatus, and
wherein the usable one or a plurality of print settings are settings determined as usable among the registered plurality of print settings.

6. The image forming apparatus according to claim 2, wherein the environmental impact acquisition unit is configured to acquire the information indicating the impact on the environment from the information processing apparatus.

7. The image forming apparatus according to claim 2, wherein the presenting unit is configured to present a print preview image indicating an appearance obtainable if printing is performed according to the selected print settings, in response to the selection of the print settings.

8. A method for an image forming apparatus, comprising:
transmitting identification information of a user who is currently operating the image forming apparatus to an information processing apparatus in response to an instruction received via an operation unit, and acquiring a list of data that correspond to the user identification information from the information processing apparatus;
displaying the list of the acquired data;
acquiring information indicating an impact on the environment if printing of the data included in the list is performed using one or a plurality of usable print settings;
performing a presentation to enable users to select an appropriate one of the acquired print settings;
acquiring the data included in the list from the information processing apparatus; and
performing print processing on the acquired data using appropriate print settings selected from the presented print settings according to a print instruction received via the operation unit,
wherein the acquired information indicating the impact on the environment is presented, in accordance with the selection of the print settings, to indicate an evaluation value corresponding to the selected print settings.

9. A non-transitory computer readable storage medium storing a computer program that causes a computer to execute a method for an image forming apparatus, the method including:
transmitting identification information of a user who is currently operating the image forming apparatus to an information processing apparatus in response to an instruction received via an operation unit, and acquiring a list of data that correspond to the user identification information from the information processing apparatus;
displaying the list of the acquired data;
acquiring information indicating an impact on the environment if printing of the data included in the list is performed using one or a plurality of usable print settings;
performing a presentation to enable users to select an appropriate one of the acquired print settings;
acquiring the data included in the list from the information processing apparatus; and
performing print processing on the acquired data using appropriate print settings selected from the presented print settings according to a print instruction received via the operation unit,
wherein the acquired information indicating the impact on the environment is presented, in accordance with the selection of the print settings, to indicate an evaluation value corresponding to the selected print settings.
